(19) United States
(12) Patent Application Publication
(10) Pub. No.: US 2015/0324866 A1
(43) Pub. Date: Nov. 12, 2015

(54) Advertising Creative Delivery to Computing Devices

(71) Applicant: Criteo SA, Paris (FR)

(72) Inventor: Alix Mougenot, Paris (FR)

(73) Assignee: Criteo SA, Paris (FR)

(21) Appl. No.: 14/274,140

(22) Filed: May 9, 2014

(51) Int. Cl. G06Q 30/02

(52) U.S. Cl. CPC G06Q 30/0277

(57) ABSTRACT

A method is performed by a computing device. A request including request data, the request data including one or more identifiers, is sent, by the computing device, to an ad decision server. Payload data, including advertising creative retrieval data for downloading one or more generated advertising creatives generated based at least in part on the request data is received asynchronously with respect to the request, by the computing device, from the ad decision server. One or more advertising creatives of the one or more generated advertising creatives is downloaded, by the computing device, based on the advertising creative retrieval data. An advertising creative display opportunity is generated by the computing device. A first advertising creative of the one or more advertising creatives is selected, by the computing device, based on advertising selection criteria. The first advertising creative is displayed, by the computing device, in the advertising creative display opportunity.

### FIELD OF THE TECHNOLOGY

The present technology relates generally to delivering advertising creatives to computing devices and, more specifically, to delivering advertising creatives in advance of an opportunity to display advertising creatives.

### BACKGROUND

Online and other electronic advertising allows advertisers to display advertisements (or ads) to end users, including those who are potential customers. For example, an application can include one or more opportunities for inserting advertisements (e.g., space for a banner advertisement, overlays, etc.). When a computing device (e.g., a mobile computing device such as a phone or tablet) is running an application in the foreground, an advertising opportunity can arise within the application. The application can request an advertisement from an advertising decision server (or ad decision server) for the advertising opportunity. The ad decision server can select an advertisement creative (e.g., an ad) for display within the area of the application display associated with the advertising opportunity. For example, the ad decision server can select a banner ad from a particular advertiser from a set of multiple banner ads from multiple advertisers for display to the user in the banner ad space of the application.

### SUMMARY OF THE TECHNOLOGY

In some instances, requesting, by a computing device, an advertising creative for an advertising opportunity after the advertising opportunity has arisen can be undesirable. For example, mobile computing devices can have limited bandwidth. Requesting an advertising creative after the advertising opportunity has arisen can result in a delay in displaying the advertising creative while it is being downloaded. In some cases, the type of media that can be included in the advertising creative can be limited due to download time considerations. As another example, mobile computing devices can have intermittent network connectivity. An application can be unable to request an advertising creative after the advertising opportunity has arisen if the mobile computing device cannot reach the network. Accordingly, there is a need for delivering advertising creatives in advance of an opportunity to display advertising creatives.

In one aspect, there is a method performed by a computing device. The method includes sending, by the computing device, to an ad decision server, a request including request data, the request data including one or more identifiers. The method includes receiving, asynchronously with respect to the request, by the computing device, from the ad decision server, payload data, wherein the payload data includes advertising creative retrieval data for downloading one or more generated advertising creatives generated based at least in part on the request data. The method includes downloading, by the computing device, from one or more servers, one or more advertising creatives of the one or more generated advertising creatives based on the advertising creative retrieval data. The method includes generating, by the computing device, an advertising creative display opportunity. The method includes selecting, by the computing device, a first advertising creative of the one or more advertising creatives based on advertising selection criteria. The method includes displaying, by the computing device, the first advertising creative in the advertising creative display opportunity.

In some embodiments, the computing device is a mobile computing device. In some embodiments, the one or more generated advertising creatives include one or more of text data, HTML, XML, JSON, executable scripts, video data, 3D model data, and image data. In some embodiments, the method includes receiving, by the computing device, a push notification including the payload data. In some embodiments, the request data further includes one or more of application data, sensor data, computing device data, tracking data, and computing device location data. In some embodiments, the advertising selection criteria specifies selection of the first advertising creative of the one or more advertising creatives based on at least one of profile data associated with at least one of the one or more identifiers, application data, sensor data, computing device data, tracking data, advertising creative priority, advertising creative expected click rate, advertising creative display window, and device location.

In some embodiments, the method includes receiving, by the computing device, from the ad decision server, a message to display a second advertising creative; and displaying, by the computing device, the second advertising creative. In some embodiments, the message is a push notification. In some embodiments, the second advertising creative is one of the one of more advertising creatives. In some embodiments, the one or more identifiers include a device identifier associated with the computing device. In some embodiments, the one or more identifiers include a push token associated with the computing device. In some embodiments, generating, by the computing device, the advertising creative display opportunity includes generating the advertising creative display opportunity on a desktop or home screen of the computing device. In some embodiments, generating, by the computing device, the advertising creative display opportunity includes generating the advertising creative display opportunity in an application executed by the computing device.

In some embodiments, the method includes generating, by the computing device, the advertising creative display opportunity; selecting, by the computing device, the first advertising creative of the one or more advertising creatives based on advertising selection criteria; and displaying, by the computing device, the first advertising creative in the advertising creative display opportunity while the computing device is disconnected from the internet and/or other networks. In some embodiments, receiving the payload data and downloading the one or more advertising creatives of the one or more generated advertising creatives is performed by an application running in the background on the computing device.

In another aspect, there is a method performed by a computing device. The method includes receiving, by the computing device, a state change notification. The method includes, in response to the state change notification, sending, by the computing device, to an ad decision server, a request including request data, the request data including one or more identifiers. The method includes, in response to the request, receiving, by the computing device, from the ad decision server, advertising creative retrieval data for downloading one or more generated advertising creatives generated based at least in part on the request data. The method includes downloading, by the computing device, from one or more servers, one or more advertising creatives of the one or more generated advertising creatives based on the advertising creative retrieval data. The method includes generating, by the computing device, an advertising creative display opportunity. The method includes selecting, by the computing device, a first advertising creative of the one or more advertising creatives based on advertising selection criteria. The method includes displaying, by the computing device, the first advertising creative in the advertising creative display opportunity.

In some embodiments, the state change notification is a callback from an operating system executing on the computing device. In some embodiments, the computing device is a mobile computing device. In some embodiments, the one or more generated advertising creatives include one or more of text data, HTML, XML, JSON, executable scripts, video data, 3D model data, and image data. In some embodiments, the request data further includes one or more of profile data, application data, sensor data, computing device data, tracking data, and computing device location data. In some embodiments, the advertising selection criteria specifies selection of the first advertising creative of the one or more advertising creatives based on at least one of profile data associated with at least one of the one or more identifiers, application data, sensor data, computing device data, tracking data, advertising creative priority, advertising creative expected click rate, advertising creative display window, and device location. In some embodiments, the one or more identifiers include a device identifier associated with the computing device. In some embodiments, generating, by the computing device, the advertising creative display opportunity includes generating the advertising creative display opportunity on a desktop or home screen of the computing device. In some embodiments, generating, by the computing device, the advertising creative display opportunity includes generating the advertising creative display opportunity in an application executed by the computing device.

In some embodiments, the method includes generating, by the computing device, the advertising creative display opportunity; selecting, by the computing device, the first advertising creative of the one or more advertising creatives based on advertising selection criteria; and displaying, by the computing device, the first advertising creative in the advertising creative display opportunity while the computing device is disconnected from the internet and/or other networks. In some embodiments, receiving the advertising creative retrieval data and downloading the one or more advertising creatives of the one or more generated advertising creatives is performed by an application running in the background on the computing device.

In another aspect, there is a method performed by an ad decision server. The method includes receiving, by the ad decision server, from a computing device, a request including request data, the request data including one or more identifiers. The method includes generating, by the ad decision server, one or more generated advertising creatives based at least in part on the request data. The method includes sending, by the ad decision server, to the computing device, payload data, wherein the payload data includes advertising creative retrieval data for downloading the one or more generated advertising creatives, wherein the wherein the payload data is sent prior to the computing device generating an advertising creative display opportunity for the one of the one or more generated advertising creatives.

In some embodiments, the method includes generating, by the ad decision server, second one or more generated advertising creatives based at least in part on a determination to update the one or more generated advertising creatives; and sending, by the ad decision server, to the computing device, second payload data, wherein the second payload data includes second advertising creative retrieval data for downloading the second one or more generated advertising creatives.

In some embodiments, the one or more generated advertising creatives include one or more of text data, HTML, XML, JSON, executable scripts, video data, 3D model data, and image data. In some embodiments, the method includes sending, by the ad decision server, to the computing device, a push notification including the payload data. In some embodiments, the request data further includes one or more of profile data, application data, sensor data, computing device data, tracking data, and device location. In some embodiments, the method includes generating, by the ad decision server, the one or more generated advertising creatives based on one or more of the profile data, application data, the sensor data, the computing device data, the tracking data, and the computing device location. In some embodiments, the method includes sending, by the ad decision server, to the computing device, a message to display a second advertising creative. In some embodiments, the message is a push notification. In some embodiments, the second advertising creative is one of the one of more generated advertising creatives. In some embodiments, the request for one or more advertising creatives is received from an application running in the background on the computing device.

Other aspects and advantages of the present technology will become apparent from the following detailed description, taken in conjunction with the accompanying drawings, illustrating the principles of the technology by way of example only.

### BRIEF DESCRIPTION OF THE DRAWINGS

The foregoing and other objects, features, and advantages of the present technology, as well as the technology itself, will be more fully understood from the following description of various embodiments, when read together with the accompanying drawings, in which:

FIG. 1 is a diagram of a network system in accordance with embodiments of the technology;

FIG. 2 depicts a flow chart illustrating a method of providing advertising creatives to a computing device in accordance with embodiments of the technology;

FIG. 3 depicts a flow chart illustrating a method of providing advertising creatives to a computing device in accordance with embodiments of the technology; and

FIG. 4 depicts a flow chart illustrating a method performed by a computing device to download and display advertising creatives.

### DETAILED DESCRIPTION

The technology described herein facilitates delivering advertising creatives in advance of an opportunity to display the advertising creatives. In an exemplary application of the technology, an application running on a computing device (e.g., a mobile computing device) can send a request including identifying information to an ad decision server to indicate to the ad decision server that the application may have one or more advertising opportunities in the future. Synchronously or asynchronously with respect to the request, the ad decision system can generate advertising creatives for the application. The ad decision system can then provide retrieval data to the application indicating that ad creatives are available for downloading. In a background process and when the computing device's connection meets certain criteria, the application can download the advertising creatives. When the application generates an advertising creative display opportunity at some later time (e.g., when the application is executing in the foreground and/or is visible to the user), the computing device already has one or more advertising creatives stored locally that can be displayed in the opportunity. Beneficially, because the computing device already has one or more advertising creatives stored locally, the application can have advertising creatives to populate advertising creative display opportunities when the computing device is disconnected from the internet and/or other networks. In some applications, advertising creatives can include more types of media (e.g., media that requires larger amounts of data) because the advertising creatives can be download in advance of when the display opportunities.

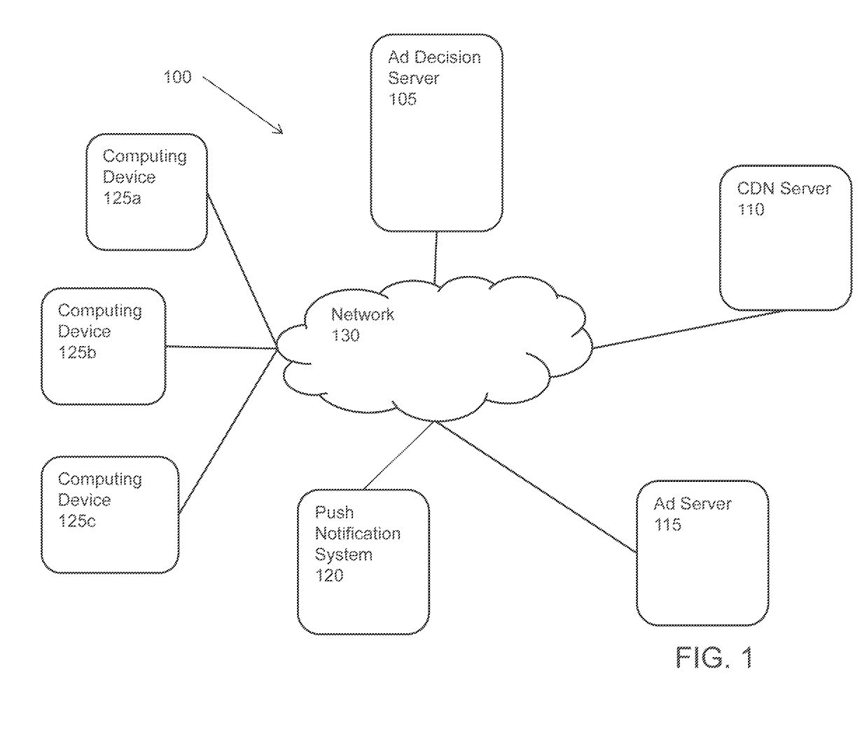

FIG. 1 is a diagram of a network system 100 in accordance with embodiments of the technology. As illustrated, network system 100 can include an ad decision server 105, content distribution network (CDN) server 110, ad server 115, push notification system 120, and computing devices 125. In network system 100, ad decision server 105, CDN server 110, ad server 115, and computing devices 125 can be in data communication with each other via network 130.

Ad decision server 105 can be any computing device, such as a server or multiple servers. In some embodiments, ad decision server 105 can generate advertising creatives as described in greater detail below. CDN server 110 can be any computing device, such as a server or multiple servers. In some embodiments, CDN server 110 can be an edge server for a content distribution network. In some embodiments, CDN server 110 can store advertising creatives and/or elements thereof (e.g., constituent images, audio files, video files, etc. of creatives). Ad server 115 can be any computing device, such as a server or multiple servers. In some embodiments, ad server 115 can store advertising creatives and/or elements thereof (e.g., constituent images, audio files, video files, etc. of creatives). Push notification system 120 can be any computing device, such as a server or multiple servers. In some embodiments, push notification system 120 can be any system for delivering push notifications to computing devices 125 (e.g., the APPLE Push Notification service or ANDROID Cloud Messaging). Computing devices 125 can be any computing devices. In some embodiments, computing devices 125 can be mobile computing devices (e.g., cellular phone and/or tablet). Network 130 can be any network or multiple networks. For example, network 130 can include cellular networks to which computing devices 125 are connected and the Internet.

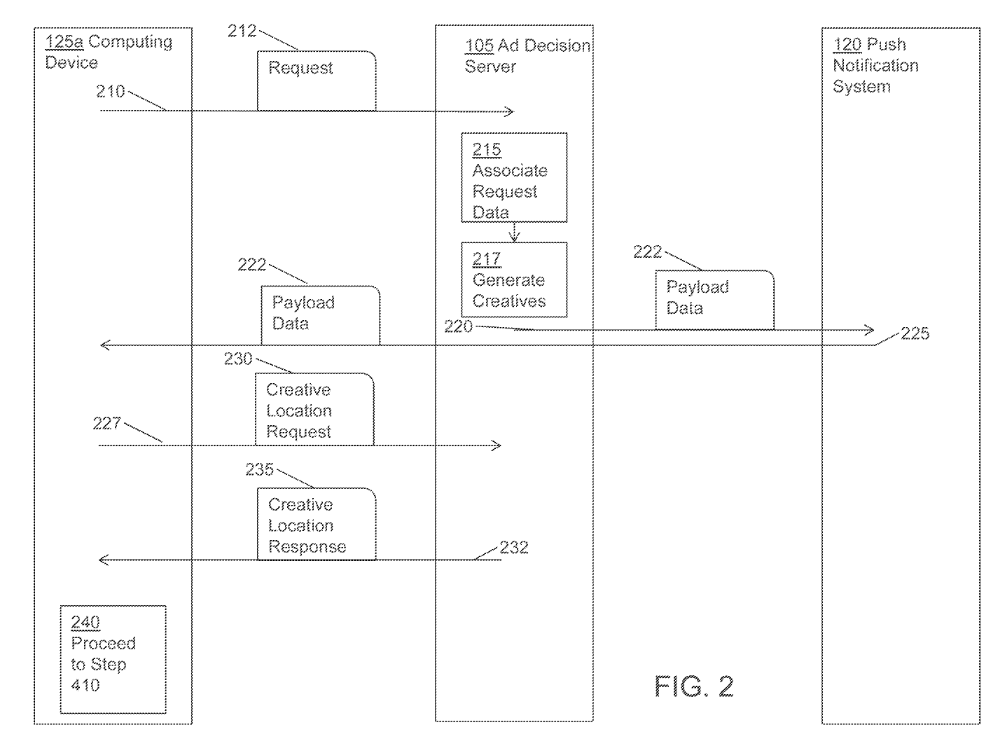

FIG. 2 depicts a flow chart illustrating a method of providing advertising creatives to computing device 125a in accordance with embodiments of the technology. In the illustrated embodiment, communications between computing device 125a, ad decision server 105, and push notification system 120 can be via network 130. At transmission step 210, computing device 125a (or an application running thereon) sends to ad decision server 105 request 212. Request 112 can include request data. The request data can include one or more identifiers. For example, the identifiers can identify computing device 125a and/or a user of computing device 125a. In some embodiments, the identifiers can include a push token associated with computing device 125a. In some embodiments, the identifiers can include a user ID. In some embodiments, the identifiers can include the identifierForAdvertising (IDFA). The request data can include information for use by ad decision server 105 in generating advertising creatives. For example, the request data can include application data (e.g., data related to the application running on computing device 125a that is sending the request), sensor data (e.g., data collected by sensors on computing device 125a), computing device data (e.g., data related to computing device 125a, such as its type, hardware, etc.), tracking data (e.g., data related to activity by the user of computing device 125a, such as retailer websites visited and/or products viewed), and computing device location data (e.g., data related to the location of computing device 125a). In some embodiments, request 212 can be sent by an application running in the background on computing device 125a.

At processing step 215, ad decision server 105 associates the request data from request 212 with a profile (e.g., a profile stored by ad decision server 105). The profile can be associated with computing device 125a. In some embodiments, the profile can be associated with a user and/or individual. Ad decision server 105 can determine to which profile to associate the request based on the one or more identifiers in request 212. In some embodiments, the profile is determined by ad decision server 105 based on the user ID. At processing step 217, ad decision server 105 generates advertising creatives based at least in part on the request data in request 212. For example, ad decision server 105 can generate ad creatives targeted to computing device 125a based on the identifiers, application data, sensor data, computing device data, tracking data, and computing device location data received in request 212. Ad decision server 105 can generate advertising creatives based at least in part on profile data (e.g., such as information about the user collected from other devices). In some embodiments, the advertising creatives can include one or more of text data, HTML, XML, JSON, executable scripts, video data, 3D model data, and image data.

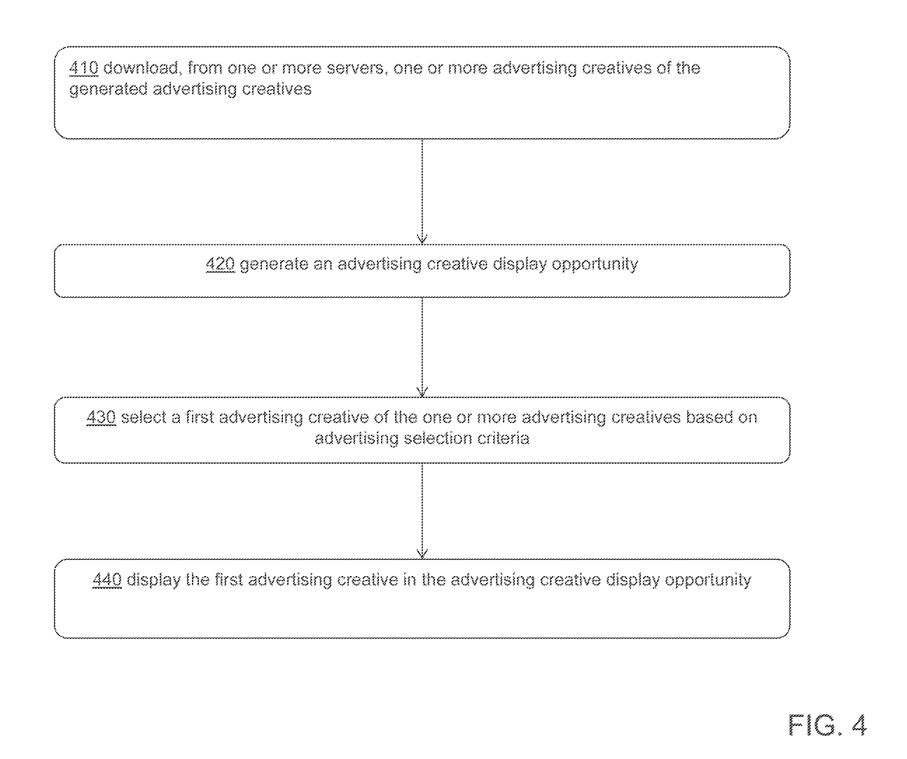

At transmission step 220, ad decision server 105 sends to push notification system 120 payload data 222 for delivery to computing device 125a as a part of a push notification. In some embodiments, the push notification can be a silent push notification (e.g., an application running on computing device 125a can process the push notification in the background). Payload data 222 can include advertising creative retrieval data to permit computing device 125a to download one or more of the advertising creatives generated in processing step 217. In some embodiments, the creative retrieval data can include a key or token which computing device 125a can provide to ad decision server 105 to retrieve the advertising creatives (e.g., when the payload data of the push notification is limited to small amounts of data). In some embodiments, the creative retrieval data can include URLs for the creatives, rules for the creatives, expiration times for the creatives, etc. At transmission step 225, push notification system 120 sends payload data 222 to computing device 125a. In some embodiments, payload data 222 is delivered to computing device 125a asynchronously with respect to request 212 (e.g., processing step 217 and transmission steps 220 and 225 can occur hours or days after request 212 is sent). In some embodiments, ad decision server 105 can periodically or in response to new data regenerate creatives (e.g., as in processing step 217) and send new payload data to computing device 125a (e.g., as in transmission steps 220 and 225). At transmission step 227, computing device 125a sends to ad decision server 105 creative location request 230. For example, computing device 125a can send a key or token from payload data 222 as a part of creative location request 230. In some embodiments, an application executing in the background on computing device 125a can send location request 230. In some embodiments, a task executing in the background on computing device 125a can send location request 230. At step 232, ad decision server 105 sends creative location response 235. Creative location response 235 can include URLs for the creatives, rules for the creatives, expiration times for the creatives, etc. As noted above, in some embodiments, URLs for the creatives, rules for the creatives, expiration times for the creatives, etc. can be sent as a part of payload data 222. In such embodiments, transmission steps 227 and 232 can be unnecessary. At processing step 240, computing device downloads the advertising creatives and displays advertising creatives as described in greater detail with respect to FIG. 4.

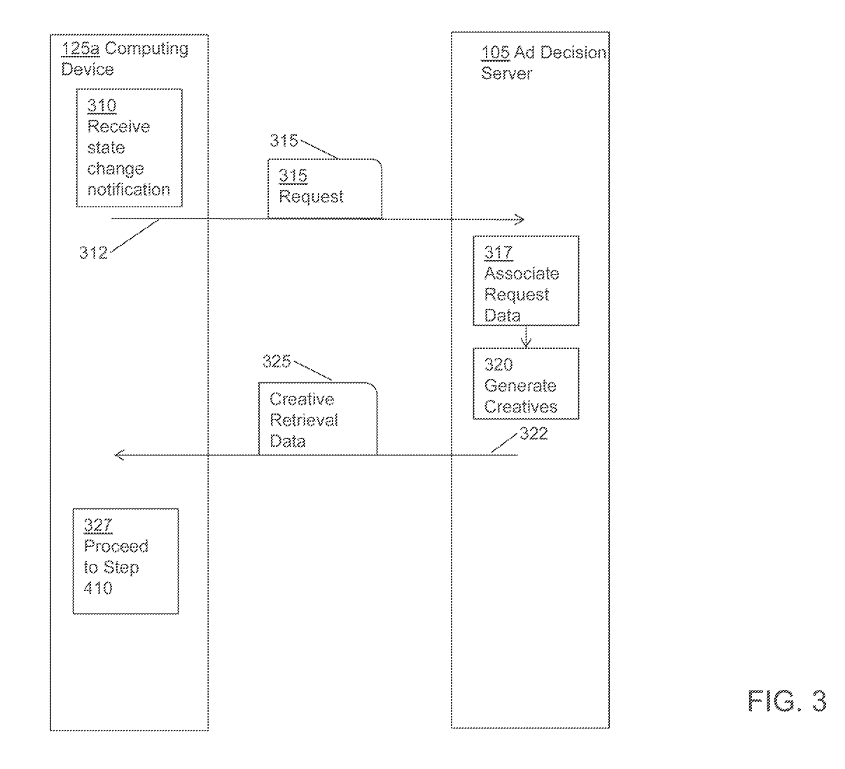

FIG. 3 depicts a flow chart illustrating another method of providing advertising creatives to computing device 125a in accordance with embodiments of the technology. In the illustrated embodiment, communications between computing device 125a and ad decision server 105 can be via network 130. At processing step 310, computing device 125a receives a state change notification. In some embodiments, the state change notification can be a callback from an operating system running on computing device 125a. For example, an operating system running on computing device 125a can send the callback when an application is likely to be executed, when computing device 125a is in a particular location, etc. An application on computing device 125a can define a callback function to be run in response to receiving the callback. In some embodiments, an operating system running on computing device 125a can invoke the callback function (e.g., in a background task). In some embodiments, an application executing in the background on computing device 125a can receive the state change notification. In some embodiments, a task executing in the background on computing device 125a can receive the state change notification.

At transmission step 312, in response to receiving the state change notification, computing device 125a sends request data 315 to ad decision server 105. For example, the callback function described above can send request data 315 to ad decision server 105. Request 315 can include any of the data as described above with respect to request 212. In some embodiments, request 315 can be sent by an application and/or tasks running in the background on computing device 125a.

At processing step 317, ad decision server 105 associates the request data from request 315 with a profile (e.g., a profile stored by ad decision server 105) as described above with respect to processing step 215. At processing step 320, ad decision server 105 generates advertising creatives based at least in part on the request data in request 315 as described above with respect to processing step 217. At transmission step 322, ad decision system sends to computing device 125a advertising creative retrieval data 325 to permit computing device 125a to download one or more of the advertising creatives generated in processing step 320. In some embodiments, the creative retrieval data can include URLs for the creatives, rules for the creatives, expiration times for the creatives, etc. At processing step 327, computing device 125a downloads the advertising creatives and displays advertising creatives as described in greater detail with respect to FIG. 4.

FIG. 4 depicts a flow chart illustrating a method performed by computing device 125c to download and display advertising creatives. In some embodiments, the method illustrated in FIG. 4 can be performed by computing device 125a after it has received data indicating the location of the advertising creatives generated as illustrated in FIG. 2 or FIG. 3. At step 410, computing device 410 downloads, from one or more servers (e.g., ad decision server 105, CDN server 110, or ad server 115), one or more advertising creatives of the generated advertising creatives. In some embodiments, downloading the one or more advertising creatives can be performed by an application and/or tasks running in the background on computing device 125a. In some embodiments, the download can be delayed based on the connectivity of computing device 125a. For example, computing device 125a can delay downloading advertising creatives until, it is connected to the Internet. Computing device 125a can delay downloading advertising creatives until, for example, it is connected to the Internet via WiFi. In some embodiments, computing device 125a can determine that the advertising creatives are stale (e.g., have expired) and can determine not to download the advertising creatives.

At step 420, computing device 125a generates an advertising creative display opportunity. In some embodiments, an application running on computing device 125a can generate an advertising creative display opportunity (e.g., the application can determine that there will be space on the screen for displaying an advertising creative). In some embodiments, an application executing in the foreground on computing device 125a can generates an advertising creative display opportunity. For example, while the creative can be downloaded by an application and/or tasks, the application can generate advertising creative display opportunities only when running in the foreground. In some embodiments, the advertising creative display opportunity can be in the context of the application (e.g., the advertising creative display opportunity can be a on a billboard or on a TV within a video game). In some embodiments the advertising creative display opportunity can be on a desktop or home screen of computing device 125a.

At step 430, computing device 125a selects a first advertising creative of the one or more advertising creatives based on advertising selection criteria. In some embodiments, the advertising selection criteria specifies selection of the first advertising creative based on at least one of profile data, application data, sensor data, computing device data, tracking data, advertising creative priority, advertising creative expected click rate, advertising creative display window, and device location. At step 440, computing device 125a displays the first advertising creative in the advertising creative display opportunity. Beneficially, computing device 125a can select and display advertising creatives from those downloaded in step 410 even when computing device 125a does not have network connectivity. In some embodiments, ad decision server 105 can send to computing device 125a a message (e.g., a push notification) to display a second advertising creative, and computing device 125a can display the second advertising creative. In some embodiments, the second advertising creative can be an advertising creative previously downloaded (e.g., at step 410).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the technology by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of a computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), a Peer-to-Peer (P2P) protocol, Hypertext Transfer Protocol (HTTP), Session Initiation Protocol (SIP), a Global System for Mobile Communications (GSM) protocol, Universal Mobile Telecommunications System (UMTS), 3GPP Long Term Evolution (LTE) and/or other communication protocols.

Devices of a computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. Mobile computing device includes, for example, a Blackberry® from Research in Motion, an iPhone® from Apple Corporation, and/or an Android™-based device.

Comprise, include, and/or plural forms of each are open ended and include the listed parts and can include additional parts that are not listed. And/or is open ended and includes one or more of the listed parts and combinations of the listed parts.

One skilled in the art will realize the technology may be embodied in other specific forms without departing from the spirit or essential characteristics thereof. The foregoing embodiments are therefore to be considered in all respects illustrative rather than limiting of the technology described herein.

What is claimed is:

1. A method performed by a computing device comprising:
a) sending, by the computing device, to an ad decision server, a request comprising request data, the request data comprising one or more identifiers;
b) receiving, asynchronously with respect to the request, by the computing device, from the ad decision server, payload data, wherein the payload data includes advertising creative retrieval data for downloading one or more generated advertising creatives generated based at least in part on the request data;
c) downloading, by the computing device, from one or more servers, one or more advertising creatives of the one or more generated advertising creatives based on the advertising creative retrieval data;
d) generating, by the computing device, an advertising creative display opportunity;
e) selecting, by the computing device, a first advertising creative of the one or more advertising creatives based on advertising selection criteria; and
f) displaying, by the computing device, the first advertising creative in the advertising creative display opportunity.

2. The method of claim 1, wherein the computing device is a mobile computing device.

3. The method of claim 1, wherein the one or more generated advertising creatives comprise one or more of text data, HTML, XML, JSON, executable scripts, video data, 3D model data, and image data.

4. The method of claim 1, further comprising receiving, by the computing device, a push notification comprising the payload data.

5. The method of claim 1, wherein the request data further comprises one or more of application data, sensor data, computing device data, tracking data, and computing device location data.

6. The method of claim 1, wherein the advertising selection criteria specifies selection of the first advertising creative of the one or more advertising creatives based on at least one of profile data associated with at least one of the one or more identifiers, application data, sensor data, computing device data, tracking data, advertising creative priority, advertising creative expected click rate, advertising creative display window, and device location.

7. The method of claim 1, further comprising:
a) receiving, by the computing device, from the ad decision server, a message to display a second advertising creative; and
b) displaying, by the computing device, the second advertising creative.

8. The method of claim 7, wherein the message is a push notification.

9. The method of claim 7, wherein the second advertising creative is one of the one of more advertising creatives.

10. The method of claim 1, wherein the one or more identifiers comprise a device identifier associated with the computing device.

11. The method of claim 1, wherein the one or more identifiers comprise a push token associated with the computing device.

12. The method of claim 1, wherein generating, by the computing device, the advertising creative display opportunity comprises generating the advertising creative display opportunity on a desktop or home screen of the computing device.

13. The method of claim 1, wherein generating, by the computing device, the advertising creative display opportunity comprises generating the advertising creative display opportunity in an application executed by the computing device.

14. The method of claim 1, further comprising generating, by the computing device, the advertising creative display opportunity; selecting, by the computing device, the first advertising creative of the one or more advertising creatives based on advertising selection criteria; and displaying, by the computing device, the first advertising creative in the advertising creative display opportunity while the computing device is disconnected from data networks.

15. The method of claim 1, wherein receiving the payload data and downloading the one or more advertising creatives of the one or more generated advertising creatives is performed by an application running in the background on the computing device.

16. A method performed by a computing device comprising:
a) receiving, by the computing device, a state change notification;
b) in response to the state change notification, sending, by the computing device, to an ad decision server, a request comprising request data, the request data comprising one or more identifiers;
c) in response to the request, receiving, by the computing device, from the ad decision server, advertising creative retrieval data for downloading one or more generated advertising creatives generated based at least in part on the request data;
d) downloading, by the computing device, from one or more servers, one or more advertising creatives of the one or more generated advertising creatives based on the advertising creative retrieval data;
e) generating, by the computing device, an advertising creative display opportunity;
f) selecting, by the computing device, a first advertising creative of the one or more advertising creatives based on advertising selection criteria; and
g) displaying, by the computing device, the first advertising creative in the advertising creative display opportunity.

17. The method of claim 16, wherein the state change notification is a callback from an operating system executing on the computing device.

18. The method of claim 16, wherein the computing device is a mobile computing device.

19. The method of claim 16, wherein the one or more generated advertising creatives comprise one or more of text data, HTML, XML, JSON, executable scripts, video data, 3D model data, and image data.

20. The method of claim 16, wherein the request data further comprises one or more of profile data, application data, sensor data, computing device data, tracking data, and computing device location data.

21. The method of claim 16, wherein the advertising selection criteria specifies selection of the first advertising creative of the one or more advertising creatives based on at least one of profile data associated with at least one of the one or more identifiers, application data, sensor data, computing device data, tracking data, advertising creative priority, advertising creative expected click rate, advertising creative display window, and device location.

22. The method of claim 16, wherein the one or more identifiers comprise a device identifier associated with the computing device.

23. The method of claim 16, wherein generating, by the computing device, the advertising creative display opportunity comprises generating the advertising creative display opportunity on a desktop or home screen of the computing device.

24. The method of claim 16, wherein generating, by the computing device, the advertising creative display opportunity comprises generating the advertising creative display opportunity in an application executed by the computing device.

25. The method of claim 16, further comprising generating, by the computing device, the advertising creative display opportunity; selecting, by the computing device, the first advertising creative of the one or more advertising creatives based on advertising selection criteria; and displaying, by the computing device, the first advertising creative in the advertising creative display opportunity while the computing device is disconnected from data networks.

26. The method of claim 16, wherein receiving the advertising creative retrieval data and downloading the one or more advertising creatives of the one or more generated advertising creatives is performed by an application running in the background on the computing device.

27. A method performed by an ad decision server comprising:
a) receiving, by the ad decision server, from a computing device, a request comprising request data, the request data comprising one or more identifiers;
b) generating, by the ad decision server, one or more generated advertising creatives based at least in part on the request data;
c) sending, by the ad decision server, to the computing device, payload data, wherein the payload data includes advertising creative retrieval data for downloading the one or more generated advertising creative, wherein the payload data is sent prior to the computing device generating an advertising creative display opportunity for the one of the one or more generated advertising creatives.

28. The method of claim 27, wherein the one or more generated advertising creatives comprise one or more of text data, HTML, XML, JSON, executable scripts, video data, 3D model data, and image data.

29. The method of claim 27, further comprising sending, by the ad decision server, to the computing device, a push notification comprising the payload data.

30. The method of claim 27, wherein the request data further comprises one or more of profile data, application data, sensor data, computing device data, tracking data, and device location; and further comprising generating, by the ad decision server, the one or more generated advertising creatives based on one or more of the profile data, application data, the sensor data, the computing device data, the tracking data, and the computing device location.
